(19) United States
(12) Patent Application Publication
(10) Pub. No.: US 2011/0261014 A1
(43) Pub. Date: Oct. 27, 2011

(54) OPTICAL TOUCH APPARATUS

(76) Inventors: Wei-Chou Chen, Hsin-Chu (TW); Cheng-Tai Huang, Hsin-Chu (TW)

(21) Appl. No.: 12/897,436

(22) Filed: Oct. 4, 2010

(30) Foreign Application Priority Data
Apr. 23, 2010 (TW) 099112904

(51) Int. Cl. G06F 3/042

(52) U.S. Cl. 345/175

(57) ABSTRACT

An optical touch apparatus is disclosed herein. The touch apparatus includes an infrared ray laser transmitting module, two infrared ray detective modules and a system controlling module. The infrared ray laser transmitting module is configured to generate an infrared ray laser light and the two infrared ray detective modules are configured to respectively detect the reflective infrared ray light reflected from a touch object. The system controlling module will receive the detective result from the infrared ray detective module so as to determine the coordinate location of the touch object.

### BACKGROUND OF THE INVENTION

1. Field of the Invention

The present invention is related to a touch apparatus, and more particularly, is related to an optical touch apparatus able to implement in different display apparatuses.

2. Description of the Prior Art

Touch control is one of the most wanted functions in electronic device, such as Personal Digital Assistant (PDA) and so on. Because the touch control function is installed in electronic device, the electronic device is become more and more easily to use. The touch technology mainly includes resistive touch, capacitive touch and optical touch. The driving method of the resistive touch is to determine the coordinate of the touch location in accordance with the voltage drop. The capacitive touch panel is a transparent conductive structure with Indium Tin Oxide (ITO) glass. The driving method of the capacitive touch is to discharge at four corners of the ITO glass so as to form a uniform electric field. When a conductive object, such as human finger, is touching on the touch panel with uniform electric field, the ratio of the current lost on the uniform electric field is calculated to determine the x axis and y axis coordinate of the touch location.

The driving method of the general optical touch is to install at least one corresponding light transmitter and light receiver at each of the x axis and y axis coordinates. The light transmitter will continually transmit the infrared ray to form a matrix. When a touch object, such as human finger, pen and so on, is touched on the panel to interfere the infrared ray at the touch location, the receivers respectively disposed in x axis and y axis will detect the location of the touch object so as to determine the touch coordinate. The driving method of the other optical touch is shown in FIG. 1 and the touch apparatus 10 includes a predefining infrared ray laser transmitting module (such as an infrared ray transmitting module in Taiwan Patent Number M368224) and an infrared ray detective module. The point light source of the infrared ray laser transmitting module will transform into the direct light source so as to emit on the entire touch region 12 in accordance with a focusing lens and a wave lens. The infrared ray detective module is configured to detect the infrared ray reflected from the touch object and the reflective infrared ray will image on the linear light sensor (such as CCD (Charge Coupled Device) or CMOS (Complementary Metal-Oxide Semiconductor)) and the linear light sensor will detect the point location in accordance with the light sensing current and the computational geometry is implemented to determine the location of the touch object.

However, the optical touch with the infrared ray laser transmitting module described above must include at least two touch apparatuses 10 respectively including an infrared ray laser module and an infrared ray detective module. The two touch apparatuses 10 are respectively disposed at two corners on the display panel or the touch region 12. According to the positional relationship between these two touch apparatuses and the angle θ generated by the reflective infrared ray of the touch object, the x axis and y axis coordinate of the touch object 14 is able to be calculated, as shown in FIG. 1. If the location of these two touch apparatus 10 wants to be changed, the accuracy of the touch detection would be effective. Therefore, the touch apparatus 10 with an infrared ray laser module and an infrared ray detective module must be fixed at the location of the external frame of the touch region 12 and they are not portable. Therefore, a need has been arisen to design a different kind of optical touch apparatus with only one set of touch module to determine the coordinate of the touch object. The accuracy of the detection won't be effective and the touch apparatus is able to switch the location.

### SUMMARY OF THE INVENTION

The main object of the present invention is to provide a touch apparatus and the touch apparatus is portable to use in different display device.

Another object of the present invention is to provide a touch apparatus including a new method to detect the touch location and reduce the number of components used in the touch apparatus.

According to the objects described above, an optical touch apparatus is disclosed in the present invention and includes an infrared ray laser transmitting module, two infrared ray detective modules and a system controlling module. The infrared ray laser transmitting module is configured to generate an infrared ray laser light. These two infrared ray detective modules are configured to respectively detect a plurality of reflective infrared rays reflected from a touch object and the system controlling module receives a detective result from the infrared ray detective module so as to determine the coordinate location of the touch object.

According to the objects described above, another optical touch apparatus is also disclosed in the present invention and includes an infrared ray laser transmitting module, two infrared ray detective modules and a system controlling module. The infrared ray laser transmitting module is configured to generate an infrared ray laser light and includes a focusing lens and a wave lens configured to transform the point light of the infrared ray laser light into the direct light so as to emit on a touch region. The two infrared ray detective modules are configured to respectively detect a plurality of reflective infrared rays reflected from a touch object and the system controlling module receives a detective result from the infrared ray detective module so as to determine the coordinate location of the touch object.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a view illustrating a conventional infrared ray laser touch apparatus;

FIG. 2 is a view illustrating an infrared ray laser touch apparatus in the present invention; and

FIG. 3 is a view illustrating an infrared ray laser touch apparatus in another embodiment of the present invention.

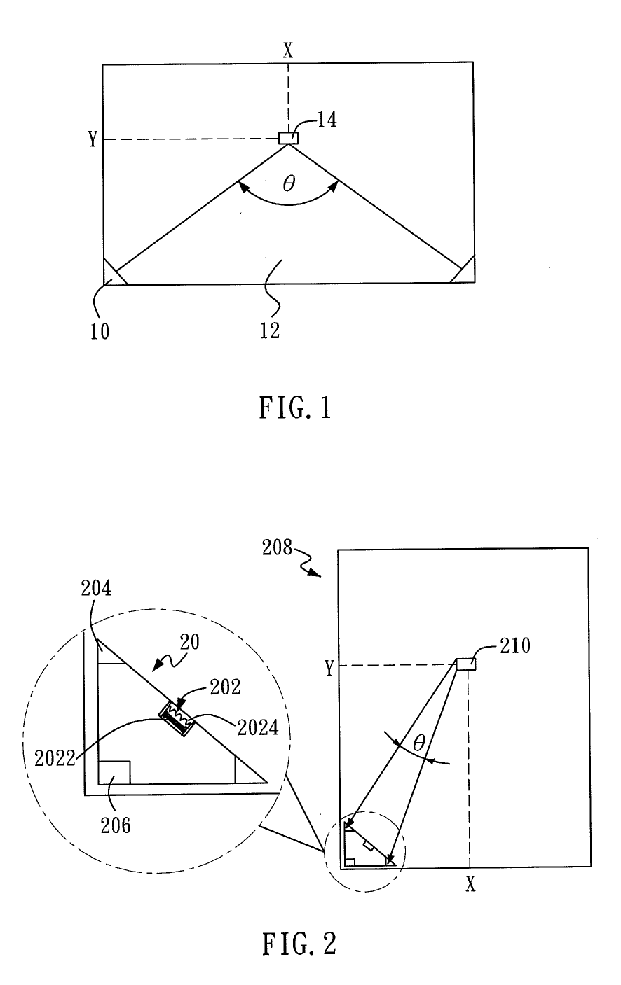

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

FIG. 2 is a plan view illustrating the touch apparatus in the present invention. As shown in FIG. 2, the touch apparatus 20 mainly includes an infrared ray laser transmitting module 202, two infrared ray detection modules 204 and a system controlling module 206. The infrared ray laser transmitting module 202 is configured to generate the infrared ray laser light and the infrared ray laser light will emit on the entire touch region 208. When the touch object 210 touches on the touch region 208, the infrared ray laser light emitting on the touch region 208 will generate a reflective infrared ray from the touch object 210, the two infrared ray detective modules 204 will respectively detect the reflective infrared ray and transmit the detective result to the system controlling module 206. The system controlling module 206 will determine the angle θ between these two reflective infrared rays detected by the infrared ray detective module 204. Subsequently, according to the distance between these two infrared ray detective module 204 and the angle θ between the reflective infrared rays, the system controlling module 206 is able to calculate the coordinate of the touch object 201. Therefore, according to the touch apparatus 20 described above, there is only one touch apparatus required in the present invention to determine the location of the touch object 210.

In addition, it should be noted that the infrared ray laser light transmitting module 202 is able to generate a direct infrared ray laser light and the infrared ray laser light transmitting module 202 further includes at least one focusing lens 2022 and one wave lens 2024 configured to let the infrared laser light transmit to the entire touch region 208. Because the infrared laser light transmitting to the entire touch region 208 in accordance with the focusing lens 2022 and the wave lens 2024 is conventional prior art, the detail description of the focusing lens 2022 and the wave lens 2024 is omitted herein. When the touch object 210 is located within the detective range of the touch region 208, the infrared ray detective module 204 will detect the reflective infrared ray generated by the infrared ray laser light emitting on the touch object 210 to acquire the angle between these two infrared detective modules 204 and the touch object 210. Therefore, the coordinate of the touch object 210 is determined.

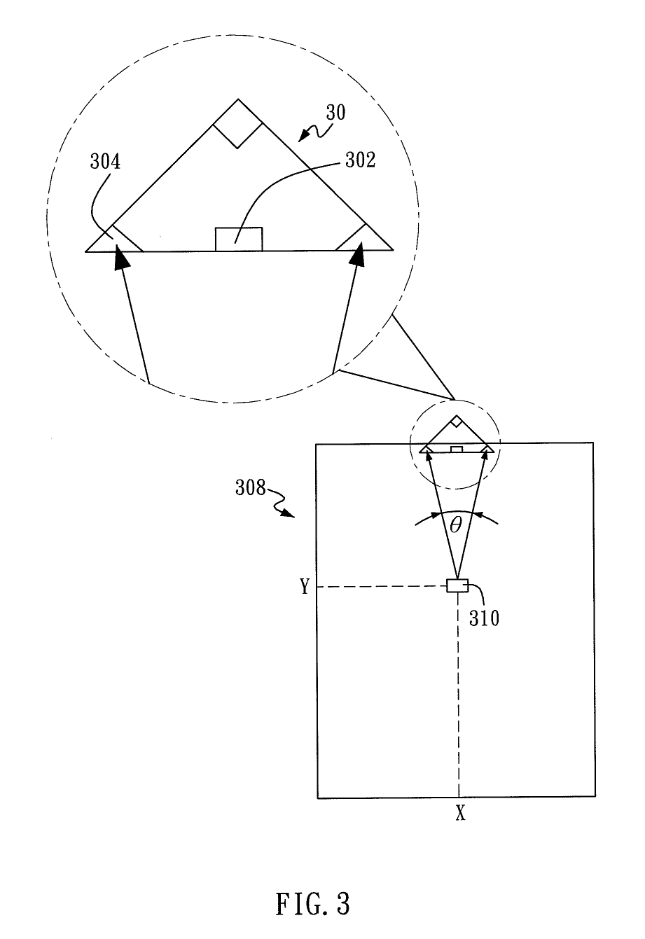

FIG. 3 is a view illustrating a touch apparatus in another embodiment of the present invention. As shown in FIG. 3, the difference between the touch apparatus 20 in FIG. 2 and the touch apparatus 30 in FIG. 3 is the disposed location of the touch apparatus on the touch region. The touch apparatus 20 in FIG. 2 is disposed at the bottom of left corner and the touch apparatus 30 in FIG. 3 is disposed at the top of center position. The infrared ray laser light transmitting module 302 will transmit the infrared ray laser light from the top to the entire touch region 308. The touch apparatus 30 in FIG. 3 also require only the angle θ between the touch object 310 and the reflective infrared ray detected by the infrared ray detective module 304 and the distance between these two infrared ray detective modules 304 to determine the coordinate of the touch object 310 in accordance with computational geometry calculated by the system controlling module 306. It is obvious to realize in FIG. 2 and FIG. 3 that the touch apparatus in the present invention is able to switch the disposed location on the touch region of the display device (for example at four corners of the periphery of the touch region) without affecting the accuracy of the touch detection. Therefore, the touch apparatus in the present invention is not necessary to be fixed on the display device and it is portable to implement in any different display device. Moreover, by comparing to the conventional touch apparatus, there are two touch apparatuses used to detect the coordinate of the touch object but there is only one touch apparatus used in the present invention to detect the coordinate of the touch object. Therefore the cost can be reduced and the touch apparatus is convenient to carry out.

Although specific embodiments have been illustrated and described, it will be appreciated by those skilled in the art that various modifications may be made without departing from the scope of the present invention, which is intended to be limited solely by the appended claims.

What is claimed is:

1. An optical touch apparatus, comprising:
an infrared ray laser transmitting module configured to generate an infrared ray laser light;
at least two infrared ray detective modules configured to respectively detect a plurality of reflective infrared rays reflected from a touch object; and
a system controlling module receiving a detective result from the infrared ray detective modules so as to determine the coordinate location of the touch object.

2. The optical touch apparatus of claim 1, wherein the infrared ray laser transmitting module includes a focusing lens and a wave lens configured to transform the point light of the infrared ray laser light into the direct light so as to emit on a touch region.

3. The optical touch apparatus of claim 2, wherein the at least two infrared ray detective modules respectively detects the reflective infrared ray light to calculate an angle between the reflective infrared rays.

4. The optical touch apparatus of claim 3, wherein the system controlling module is configured to determine the coordinate of the touch object in accordance with a predefined distance between the infrared ray detective modules and the angle between the reflective infrared rays.

5. The optical touch apparatus of claim 2, wherein the optical touch apparatus is disposed in the periphery of the touch region.

6. The optical touch apparatus of claim 1, wherein the infrared ray laser light is a direct light source.

7. An optical touch apparatus, comprising:
an infrared ray laser transmitting module configured to generate an infrared ray laser light and includes a focusing lens and a wave lens configured to transform the point light of the infrared ray laser light into the direct light so as to emit on a touch region;
at least two infrared ray detective modules configured to respectively detect a plurality of reflective infrared rays reflected from a touch object; and
a system controlling module receiving a detective result from the infrared ray detective module so as to determine the coordinate location of the touch object.

8. The optical touch apparatus of claim 7, wherein the at least two infrared ray detective modules respectively detect the reflective infrared ray light to calculate an angle between the reflective infrared rays.

9. The optical touch apparatus of claim 7, wherein the system controlling module is configured to determine the coordinate of the touch object in accordance with a predefined distance between the infrared ray detective modules and the angle between the reflective infrared rays.

10. The optical touch apparatus of claim 7, wherein the optical touch apparatus is disposed in the periphery of the touch region.
